(19) United States
(12) Patent Application Publication
(10) Pub. No.: US 2023/0410148 A1
(43) Pub. Date: Dec. 21, 2023

(54) SERVICE MANAGEMENT SYSTEM AND SERVICE MANAGEMENT METHOD

(71) Applicant: TOYOTA JIDOSHA KABUSHIKI KAISHA, Toyota-shi (JP)

(72) Inventors: Hiroya MATSUBAYASHI, Tokyo-to (JP); Tomoyuki KAGA, Mishima-shi (JP); Yuki ICHIOKA, Kawasaki-shi (JP); Hideo HASEGAWA, Nagoya-shi (JP); Nobuhisa OTSUKI, Tokyo-to (JP)

(73) Assignee: TOYOTA JIDOSHA KABUSHIKI KAISHA, Toyota-shi (JP)

(21) Appl. No.: 18/303,997

(22) Filed: Apr. 20, 2023

(30) Foreign Application Priority Data
Jun. 20, 2022 (JP) 2022-098970

(51) Int. Cl. G06Q 30/0251; G06Q 30/0202

(52) U.S. Cl. CPC G06Q 30/0255; G06Q 30/0202

(57) ABSTRACT

A service management system for managing a service includes: one or more memory devices configured to store user personality information indicating personality for each user of the service; and one or more processors. The one or more processors are configured to execute: a service simulation process that simulates a state of the service to estimate a level of the service, based on demand forecast information for the service; and a change promotion process that notifies a user of change promotion information that promotes a change in a requirement or an action for the service, when the level of the service is lower than a predetermined level. The change promotion process includes notifying the change promotion information according to the personality of the user based on the user personality information.

### CROSS-REFERENCE TO RELATED APPLICATION

This application claims priority to Japanese Patent Application No. 2022-098970 filed on Jun. 20, 2022, the entire contents of which are incorporated by reference herein.

### TECHNICAL FIELD

### Background

The present disclosure relates to a technique for managing a service.

### Background Art

Patent Literature 1 discloses a power system control support system that supports power adjustment of a power system. When it is expected that power demand exceeds power supply, the power system control support system prompts consumers to take actions to suppress power consumption. In addition, when power generation amount is excessive, the power system control support system urges the consumers to take actions to increase the power consumption.

### LIST OF RELATED ART

Patent Literature 1: Japanese Laid-Open Patent Application No. JP-2021-192140

### SUMMARY

In providing a service, an increase in a service load causes a decrease in a service level (i.e., service quality). Therefore, when the decrease in the service level due to the increase in the service load is predicted, it is conceivable to take a measure to distribute the service load. Here, taking a measure haphazardly is inefficient. There is room for improvement in distributing the service load.

An object of the present disclosure is to provide a technique capable of efficiently distributing a service load.

A first aspect is directed to a service management system for managing a service.

The service management system include:
one or more memory devices configured to store user personality information indicating personality for each user of the service; and
one or more processors.

The one ore more processors are configured to execute:
a service simulation process that simulates a state of the service to estimate a level of the service, based on demand forecast information for the service; and
a change promotion process that notifies a user of change promotion information that promotes a change in a requirement or an action for the service, when the level of the service is lower than a predetermined level.

The change promotion process includes notifying the change promotion information according to the personality of the user based on the user personality information.

A second aspect is directed to a service management method for managing a service.

The service management method includes:
a service simulation process that simulates a state of the service to estimate a level of the service, based on demand forecast information for the service; and
a change promotion process that notifies a user of the service of change promotion information that promotes a change in a requirement or an action for the service, when the level of the service is lower than a predetermined level.

The change promotion process includes:
acquiring user personality information indicating personality for each user of the service; and
notifying the change promotion information according to the personality of the user based on the user personality information.

According to the present disclosure, when the service level estimated by the service simulation process is lower than a predetermined level, the user is notified of the change promotion information that promotes the change in the requirement or the action for the service. This makes it possible to distribute the service load and thus to suppress the decrease in the service level. Furthermore, the change promotion information is not notified haphazardly, but the change promotion information according to the personality of the user is notified to the user. This makes it possible to efficiently distribute the service load.

### BRIEF DESCRIPTION OF DRAWINGS

FIG. 1 is a conceptual diagram for explaining an overview of a service management system according to an embodiment;

FIG. 2 is a block diagram showing an example of a functional configuration related to a change promotion process performed by a service management system according to an embodiment;

FIG. 3 is a flowchart summarizing processing related to a change promotion process performed by the service management system according to an embodiment;

FIG. 4 is a conceptual diagram showing a first example of user personality information according to an embodiment;

FIG. 5 is a conceptual diagram showing a second example of user personality information according to an embodiment;

FIG. 6 is a conceptual diagram showing a third example of user personality information according to an embodiment;

FIG. 7 is a block diagram showing an example of a functional configuration related to a demand forecast process performed by a service management system according to an embodiment;

FIG. 8 is a block diagram showing a functional configuration example related to a change promotion process and a demand forecast process performed by a service management system according to an embodiment; and

FIG. 9 is a block diagram showing an example of a hardware configuration of a service management system according to an embodiment.

### EMBODIMENTS

Embodiments of the present disclosure will be described with reference to the accompanying drawings.

### 1. Service Management System

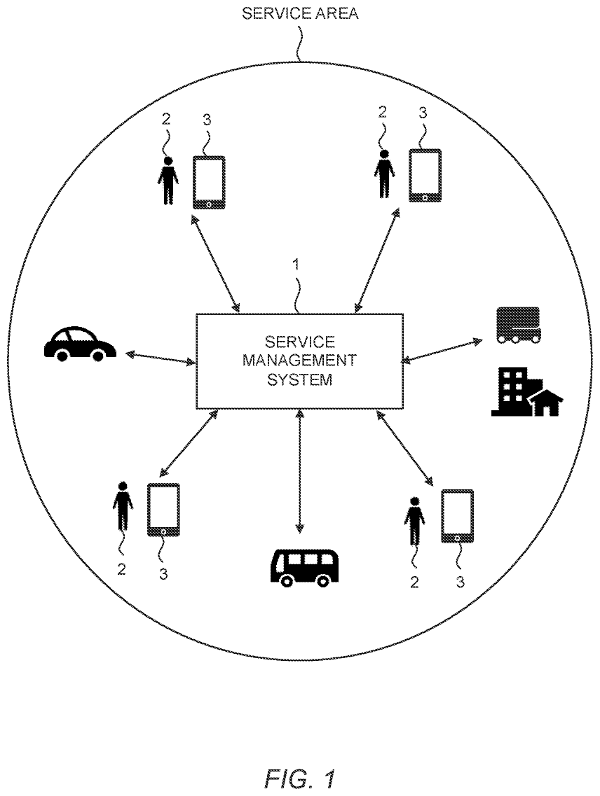

FIG. 1 is a conceptual diagram for explaining an overview of a service management system 1 according to the present embodiment. The service management system 1 manages one or more services provided in a certain area. The service management system 1 includes one or more management devices. The service management system 1 may be configured by a plurality of management devices that perform distributed processing.

A service area is, for example, one city such as a smart city. Examples of the service include a logistics service, a mobility service, and a product sales service. The logistics service is a service for transporting an object to a destination. The transportation of the object may be performed by a human, or may be performed by a logistics robot having an autonomous mobile function. The mobility service is a service for transporting a human by utilizing a vehicle. The vehicle may be a vehicle driven by a driver or may be an autonomous driving vehicle. Examples of the mobility service include a taxi service, a bus service, a ride-sharing service, and the like. The product sales service is also called electronic commerce (EC).

For example, the service management system 1 performs a simulation of each service. In the service simulation, a service parameter defining a service content and a service capability are set. Examples of the service parameter of the logistics service include the number of staffs, the number of logistics robots, an amount of charge of the logistics robot, a delivery route, a delivery time, and the like. Examples of the service parameter of the mobility service include the number of staffs, the number of vehicles, an amount of charge of the vehicle, a vehicle travel route, service hours, and the like. Examples of the service parameter of the product sales service include a type of product, an amount of products, and the like.

It is possible to design a suitable service form through such the service simulation. For example, it is possible to find a vital part of the service and to consider an improvement plan. In addition, it is possible through the service simulation to check whether a desired service level (service quality) is secured. In addition, it is possible through the service simulation to determine the service parameter necessary for securing a desired service level.

Examples of the service level (service quality) include a waiting time from a service application to service provision, punctuality, a degree of congestion in a vehicle, power consumption, and the like. The shorter the waiting time, the higher the service level. The higher the punctuality, the higher the service level. The lower the degree of congestion in the vehicle, the higher the service level. The lower the power consumption, the higher the service level.

The service management system 1 may collect information in a real world and reproduce a real-world service state in a virtual world in real time. Such a technique is also called Digital Twin. Furthermore, the service management system 1 may execute the service simulation in the virtual world to predict a future service state.

A user 2 of the service uses a user terminal 3 to use the service. Examples of the user terminal 3 include a mobile terminal such as a smartphone, a PC, and the like. By using the user terminal 3, the user 2 can apply for a service, make a reservation of a service, designate a time of a service, change a service, and the like. The user terminal 3 transmits information input by the user 2 using the user terminal 3 to the service management system 1. Furthermore, the user terminal 3 may notify the service management system 1 of an action of the user 2 related to the service.

The service management system 1 may provide a variety of information related to the service to the user 2 (i.e., the user terminal 3). For example, the service management system 1 transmits service information useful for the user 2 to the user terminal 3. As another example, the service management system 1 may transmit information for securing a service level to the user terminal 3.

### 2. Change Promotion Process

### 2-1. Overview

In providing the service, an increase in a service load causes a decrease in the service level. Therefore, when the decrease in the service level due to the increase in the service load is predicted, it is conceivable to take a measure to distribute the service load.

The service management system 1 according to the present embodiment simulates a state of the service based on demand forecast for the service. When the service level estimated by the service simulation is lower than a predetermined level, the service management system 1 notifies the user 2 of “change promotion information PRM”, that is, transmits the change promotion information PRM to the user terminal 3. The change promotion information PRM is information intended to distribute the service load. More specifically, the change promotion information PRM is information for promoting (encouraging) the user 2 to change a requirement or an action for the service. Typically, the change promotion information PRM conditionally offers a privilege to the user 2.

As an example, a case where the user 2 has already designated a desired delivery date Da of a certain product and a large number of other delivery schedules are concentrated on the desired delivery date Da is considered. In this case, the change promotion information PRM promotes (encourages) the user 2 to change the requirement for the service, for example, “if you could change the desired delivery date from Da to db, we will give you a privilege.” The user 2 who receives such the change promotion information PRM is likely to consider changing the desired delivery date to db. In the case where the user 2 changes the desired delivery date from Da to db, the service load on Da is reduced and thus the decrease in the service level is suppressed.

As another example, a case where the user 2 who regularly purchases a certain product P is predicted to place a next order of the product P in a period Ta and lots of other orders are predicted to concentrate on the same period Ta is considered. In this case, the change promotion information PRM prompts (encourages) the user 2 to change the action for the service, for example, “if you could put an order of the product P by the period Ta, we will give you a privilege.” The user 2 who receives such the change promotion information PRM is likely to consider ordering the product P at a timing earlier than usual. In the case where the user 2 orders the product P before the period Ta, the service load during the period Ta is reduced and thus the decrease in the service level is suppressed.

The process of notifying the user 2 of the change promotion information PRM (i.e., transmitting the change promotion information PRM to the user terminal 3) is hereinafter referred to as a “change promotion process.” The change promotion process is a kind of an information providing process performed by the service management system 1.

However, it is not necessarily efficient to haphazardly notify the change promotion information PRM. The reason is that sensitivity to information varies depending on the user 2. It is inefficient to notify a user 2 with a low sensitivity to information of the change promotion information PRM. Moreover, there are a variety of attributes of the users 2, and it is also inefficient to notify a group of users with similar attribute of different change promotion information PRM.

In view of the above, the service management system 1 according to the present embodiment is configured to efficiently perform the change promotion process in consideration of “personality” of each user 2. That is, the service management system 1 is configured to notify the user 2 of the change promotion information PRM according to the personality of the user 2.

### 2-2. Functional Configuration Example

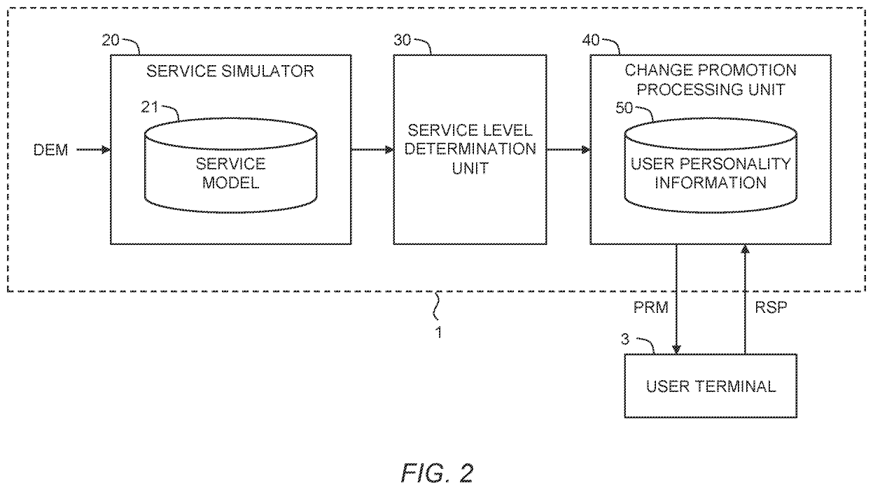

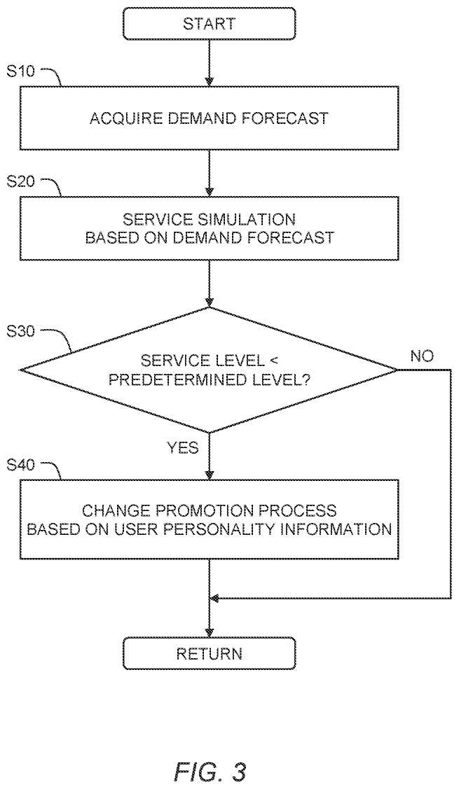

FIG. 2 is a block diagram showing an example of a functional configuration related to the change promotion process performed by the service management system 1. The service management system 1 includes a service simulator 20, a service level determination unit 30, and a change promotion processing unit 40. FIG. 3 is a flowchart summarizing the processing related to the change promotion process performed by the service management system 1.

### 2-2-1. Demand Forecast Process (Step S10)

In Step S10, the service management system 1 predicts a demand for the service to acquire demand forecast information DEM indicating the demand forecast. An example of the demand forecast process will be described in Section 3 below.

### 2-2-2. Service Simulation Process (Step S20)

In Step S20, the service simulator 20 executes a service simulation process that simulates a state of the service. The demand forecast information DEM is input to the service simulator 20. Based on the demand forecast indicated by the demand forecast information DEM, the service simulator 20 simulates the state of the service to estimate the service level related to the service.

More specifically, the service simulator 20 includes a service model 21. The service model 21 is configured to calculate the service level based on the service parameter and the demand forecast. The service parameter defines a service content and a service capability. Examples of the service parameter of the logistics service include the number of staffs, the number of logistics robots, an amount of charge of the logistics robot, a delivery route, a delivery time, and the like. Examples of the service parameter of the mobility service include the number of staffs, the number of vehicles, an amount of charge of the vehicle, a vehicle travel route, service hours, and the like. Examples of the service parameter of the product sales service include a type of product, an amount of products, and the like. The service model 21 may be generated through machine learning. A type of the machine learning model is not particularly limited.

### 2-2-3. Service Level Determination Process (Step S30)

In Step S30, the service level determination unit 30 determines whether or not the service level estimated in Step S20 is lower than a predetermined level. When the service level is lower than the predetermined level (Step S30; Yes), the processing proceeds to Step S40. Otherwise (Step S30; No), Step S40 is skipped.

### 2-2-4. Change Promotion Process (Step S40)

In Step S40, the change promotion processing unit 40 executes the change promotion process that notifies the user 2 of the change promotion information PRM. More specifically, the change promotion processing unit 40 holds user personality information 50 that indicates personality for each user 2 of the service. A specific example of the user personality information 50 will be described later. Based on the user personality information 50, the change promotion processing unit 40 transmits the change promotion information PRM according to the personality of the user 2 to the user terminal 3.

The user 2 sees the change promotion information PRM received by the user terminal 3. The user 2 who sees the change promotion information PRM may change a requirement or an action for the service. User reaction information RSP is information indicating an actual reaction of the user 2 to the change promotion information PRM. For example, the user reaction information RSP indicates that the user 2 has actually changed a content of reservation for the service in line with the proposal by the change promotion information PRM. As another example, the user reaction information RSP indicates that the user has actually applied for a new service use in line with the proposal by the change promotion information PRM. As yet another example, the user reaction information RSP may indicate that the user 2 has made no reaction to the change promotion information PRM. The user terminal 3 returns the user reaction information RSP to the service management system 1. It can be said that the user reaction information RSP reflects the personality of the user 2. Therefore, the service management system 1 (the change promotion processing unit 40) is able to update the user personality information 50 based on the user reaction information RSP.

Hereinafter, various examples of the change promotion process will be described.

### 2-3. Various Examples of Change Promotion Process

### 2-3-1. First Example

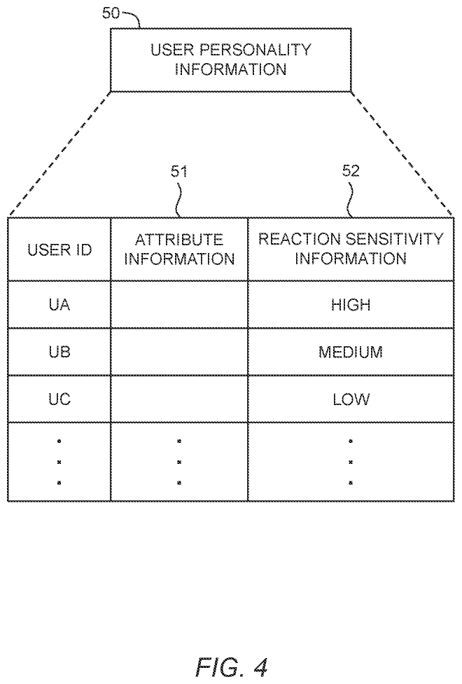

FIG. 4 is a conceptual diagram showing a first example of the user personality information 50. The user personality information 50 includes attribute information 51 that indicates an attribute for each user 2. Examples of the attribute of the user 2 include age, sex, residence, occupation, and the like.

The user personality information 50 further includes reaction sensitivity information 52. The reaction sensitivity information 52 indicates a reaction sensitivity to the change promotion information PRM for each user 2. For example, the reaction sensitivity to the change promotion information PRM is a probability that the user 2 follows the proposal by the change promotion information PRM.

For example, the reaction sensitivity information 52 indicates a past record of the reaction sensitivity to the change promotion information PRM. Such the reaction sensitivity information 52 is generated and updated based on the user reaction information RSP with respect to the change promotion information PRM in the past. The service management system 1 (the change promotion processing unit 40) generates and updates the reaction sensitivity information 52 in the user personality information 50 based on the user reaction information RSP received from the user terminal 3.

As another example, the reaction sensitivity information 52 may indicate an estimated value of the reaction sensitivity to the change promotion information PRM. In this case, the reaction sensitivity of each user 2 is estimated based on the attribute information 51 regarding the each user 2. For example, it is expected that the user 2 of a generation having time to spare is highly likely to accept a change in the delivery date and time.

The reaction sensitivity information 52 may represent the reaction sensitivity for each user 2 by multiple levels (e.g., high, medium, and low). The level of the reaction sensitivity is determined by comparing a value of the reaction sensitivity with a threshold value.

In the first example, the change promotion processing unit 40 selectively notifies the change promotion information PRM only to the user 2 having a high reaction sensitivity based on the reaction sensitivity information 52. That is, the change promotion processing unit 40 notifies only a user 2 whose reaction sensitivity is equal to or higher than a first threshold of the change promotion information PRM, without notifying another user 2 whose reaction sensitivity is lower than the first threshold of the change promotion information PRM.

Accordingly, it is possible to suppress the notification of the change promotion information PRM which is considered to be less effective. In other words, useless change promotion process is prevented from being performed. Selectively notifying the change promotion information PRM only to the user 2 having a high reaction sensitivity makes it possible to efficiently perform the change promotion process. That is, it is possible to efficiently distribute the service load.

It should be noted that the user terminal 3 may return the user reaction information RSP to the service management system 1. In this case, the service management system 1 (the change promotion processing unit 40) updates the reaction sensitivity information 52 based on the user reaction information RSP.

### 2-3-2. Second Example

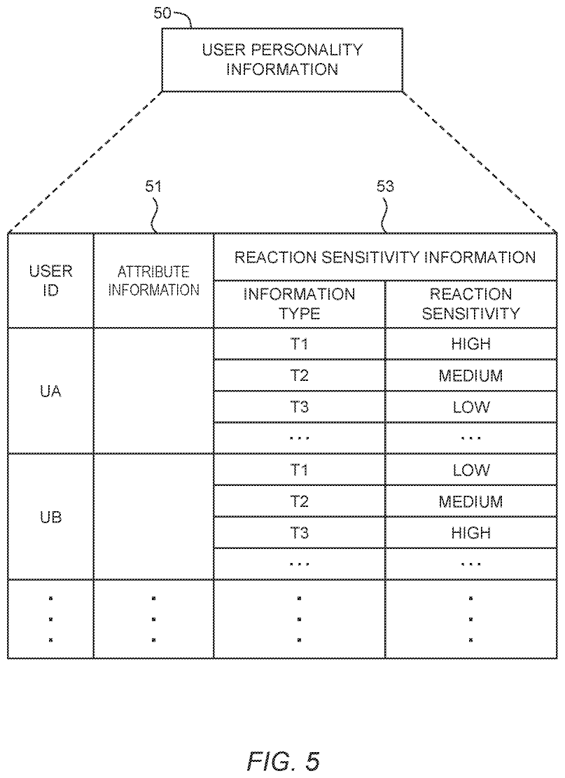

FIG. 5 is a conceptual diagram showing a second example of the user personality information 50. A description overlapping with the above-described first example will be omitted as appropriate. In the second example, the user personality information 50 includes reaction sensitivity information 53. The reaction sensitivity information 53 indicates, for each user 2, a correspondence relationship between a type (content) of the change promotion information PRM and the reaction sensitivity to the change promotion information PRM. Examples of the type (content) of the change promotion information PRM include a proposal to change a designated date, a proposal to change a designated time, a proposal to change a designated vehicle type, a proposal to purchase a product, and the like. As in the case of the first example described above, the reaction sensitivity may be a past actual value or may be an estimated value.

Even for the same user 2, the reaction sensitivity to the change promotion information PRM may vary depending on the type of the change promotion information PRM. Therefore, in the second example, the change promotion processing unit 40 selectively notifies the user 2 of the change promotion information PRM of a type related to a high reaction sensitivity based on the reaction sensitivity information 53. That is, the change promotion processing unit 40 notifies the user 2 of the change promotion information PRM of a type related to the reaction sensitivity equal to or higher than a second threshold, without notifying the user 2 of the change promotion information PRM of another type related to the reaction sensitivity lower than the second threshold.

Accordingly, it is possible to suppress the notification of the change promotion information PRM which is considered to be less effective. In other words, useless change promotion process is prevented from being performed. Selectively notifying the change promotion information PRM of a type related to a high reaction sensitivity makes it possible to efficiently perform the change promotion process. That is, it is possible to efficiently distribute the service load.

It should be noted that the user terminal 3 may return the user reaction information RSP to the service management system 1. In this case, the service management system 1 (the change promotion processing unit 40) updates the reaction sensitivity information 52 based on the user reaction information RSP.

### 2-3-3. Third Example

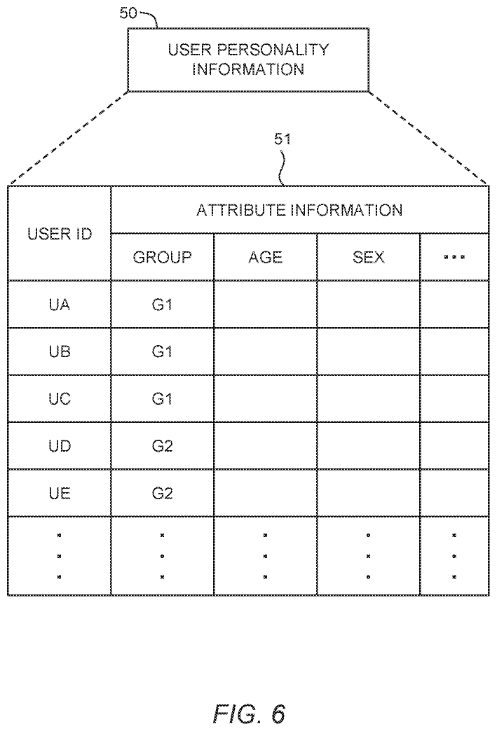

FIG. 6 is a conceptual diagram showing a third example of the user personality information 50. In the third example, the attribute information 51 of the user personality information 50 includes a group to which the user 2 belongs. Examples of the group include a residential area, a condominium, a company, a school, a classroom, and the like. The change promotion processing unit 40 notifies all users 2 belonging to the same group of the same change promotion information PRM based on the attribute information 51.

By notifying all users 2 belonging to the same group of the same change promotion information PRM, it is possible to prevent a feeling of unfairness in the same group from occurring.

### 2-4. Effects

As described above, according to the present embodiment, when the service level estimated by the service simulation process is lower than a predetermined level, the user 2 is notified of the change promotion information PRM that promotes the change in the requirement or the action for the service. This makes it possible to distribute the service load and thus to suppress the decrease in the service level.

Furthermore, according to the present embodiment, the change promotion information PRM is not notified haphazardly, but the change promotion information PRM according to the personality of the user 2 is notified to the user 2. This makes it possible to efficiently distribute the service load.

### 3. Example of Demand Forecast Process

As described above, the service management system 1 predicts the demand for the service to acquire the demand forecast information DEM indicating the demand forecast (Step S10). An example of the demand forecast process will be described.

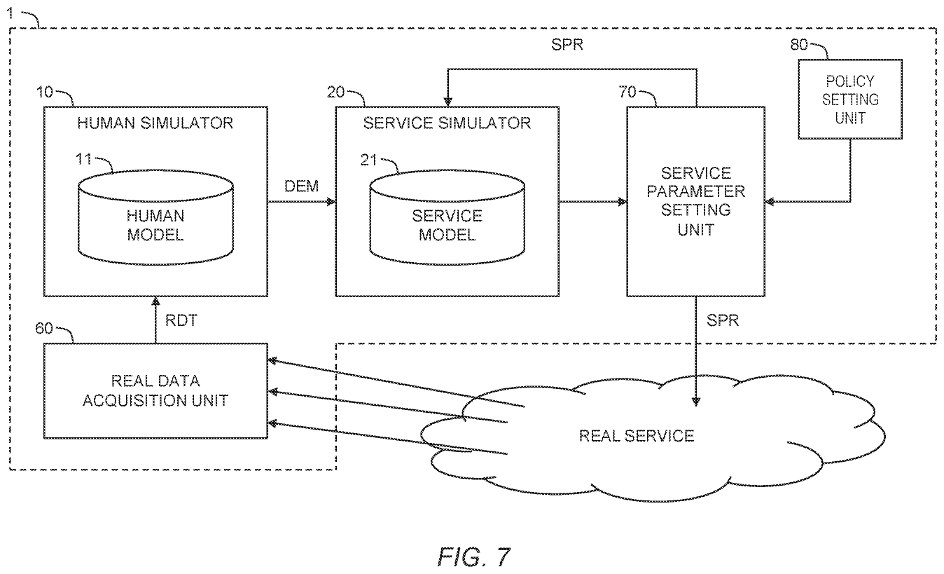

FIG. 7 is a block diagram showing an example of a functional configuration related to the demand forecast process. The service management system 1 includes a human simulator 10, the service simulator 20, a real data acquisition unit 60, a service parameter setting unit 70, and a policy setting unit 80.

The human simulator 10 predicts the demand for the service by simulating an action of each user 2. More specifically, the human simulator 10 includes a human model 11 that is an action model of the user 2. In the human model 11, the action of the user 2 using the service is modeled. Real data RDT indicating at least one of an actual action history and an action schedule of the user 2 is input to the human model 11.

The actual action history of the user 2 includes current and past actions of the user 2. The actual action history of the user 2 includes, for example, a purchase history of a product P. Based on the purchase history, it is possible to predict a next timing when the user 2 will purchase the product P. When the user 2 has recently purchased the product P, it can be predicted that the user 2 will not purchase the product P for a while. As another example, the actual action history of the user 2 includes a usage history of a mobility service. Based on the usage history, it is possible to predict a next date and time when the user 2 will use the mobility service. As still another example, the actual action history of the user 2 includes consumption of a certain food stored in a refrigerator. In this case, it can be predicted that the user 2 will purchase and restock the food in the near future.

The action schedule of the user 2 is registered in advance by the user 2. For example, the action schedule of the user 2 includes a schedule of using the mobility service at a specific date and time. The service management system 1 holds information on the action schedule registered by the user 2. It is possible to predict the demand for the service based on the action schedule.

The real data acquisition unit 60 collects the real data RDT indicating at least one of the actual action history and the action schedule of the user 2 from various devices in the real world. For example, the real data acquisition unit 60 acquires real data RDT from the user terminal 3 of each user 2. As another example, a camera that captures the action of the user 2 may be installed, and the real data acquisition unit 60 may acquire the real data RDT based on an image captured by the camera. The real data acquisition unit 60 provides the real data RDT to the human simulator 10.

The human model 11 is configured to calculate (predict) the demand for the service based on the real data RDT. The human model 11 may be generated through machine learning. A type of the machine learning model is not particularly limited. The human model 11 is prepared for each user 2. Alternatively, the same human model 11 may be used for a group of users having the same attribute. For example, the same human model 11 may be used for a group of users of the same age.

The human simulator 10 simulates the action of each user 2 by using such the human model 11 to predict the demand for the service and acquire the demand forecast information DEM. More specifically, the human simulator 10 simulates the action of each user 2 by inputting the real data RDT acquired from the real data acquisition unit 60 to the human model 11. The demand forecast information DEM is acquired by such the user simulation process.

The service simulator 20 is the same as that shown in FIG. 2. The demand forecast information DEM output from the human simulator 10 is input to the service simulator 20. The service simulator 20 simulates the state of the service based on the demand forecast information DEM and the service parameter SPR to estimates the service level related to the service.

The service parameter setting unit 70 determines whether or not the service level estimated by the service simulator 20 is equal to or higher than a predetermined level. When the service level is lower than the predetermined level, the service parameter SPR may be insufficient for the demand forecast. Therefore, when the service level is lower than the predetermined level, the service parameter setting unit 70 changes the service parameter SPR so as to improve the service level. The service parameter setting unit 70 feeds back the changed service parameter SPR to the service simulator 20. The service simulator 20 performs the service simulation process based on the changed service parameter SPR.

A service provider may provide a setting policy of the service parameter SPR in advance. For example, the service provider may designate in advance a possible range of the service parameter SPR. As another example, the service provider may predefine a relationship between a certain service parameter SPR and another service parameter SPR. For example, in the case of the mobility service, the number of vehicles used is set to be inversely proportional to an operation time. The policy setting unit 80 outputs the setting policy given from the service provider to the service parameter setting unit 70. The service parameter setting unit 70 sets the service parameter SPR in accordance with the setting policy.

When the service level estimated by the service simulator 20 is equal to or higher than the predetermined level, the service parameter setting unit 70 presents the service parameter SPR to the service provider. The service provider reflects the service parameter SPR presented by the service management system 1 on the real service in the real world.

The real data acquisition unit 60 acquires the latest real data RDT and feeds back the latest real data RDT to the human simulator 10.

According to the demand forecast process shown in FIG. 7, it is possible to predict the demand for the service with high accuracy based on the real data RDT. Then, since the service simulation process is performed based on the highly accurate demand forecast information DEM, it is possible to determine with high accuracy the service parameter necessary for securing the service level equal to or higher than the predetermined level. The highly accurate service parameter is reflected in the real service in the real world. As a result, the service level of the real service is maintained at the predetermined level or higher.

### 4. Combination

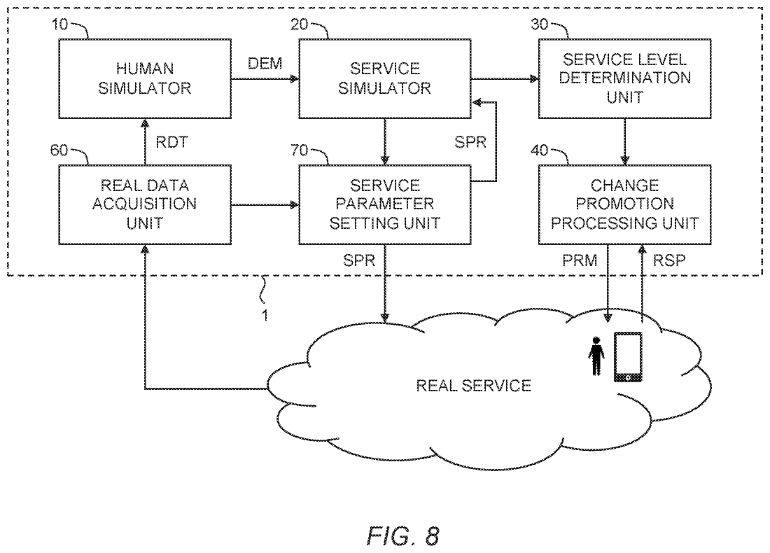

FIG. 8 shows a combination of the change promotion process described in Section 2 (see FIG. 2) and the demand forecast process described in Section 3 (see FIG. 7). The user reaction information RSP may be included in the real data RDT. In this case, the change promotion processing unit 40 updates the user personality information based on the user reaction information RSP included in the real data RDT.

### 5. Hardware Configuration Example

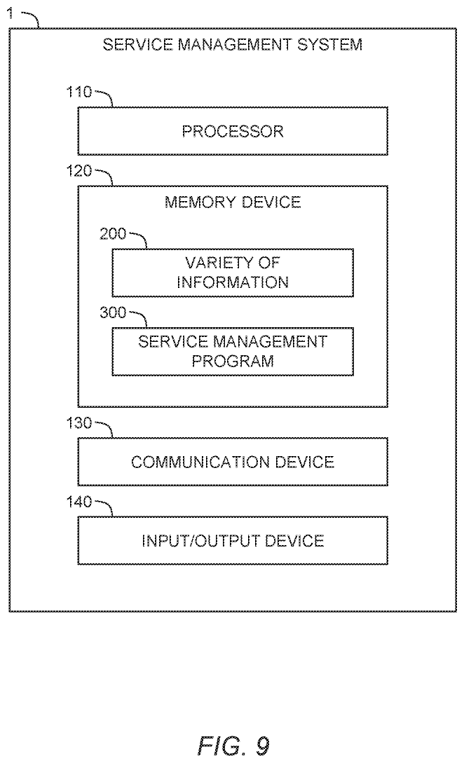

FIG. 9 is a block diagram showing an example of a hardware configuration of the service management system 1 according to the present embodiment. The service management system 1 includes one or more processors 110 (hereinafter, simply referred to as a “processor 110”), one or more memory devices 120 (hereinafter, simply referred to as a “memory device 120”), a communication device 130, and an input/output device 140.

The processor 110 executes a variety of information processing. For example, the processor 110 includes a central processing unit (CPU). The memory device 120 stores a variety of information 200 necessary for the processing by the processor 110. The variety of information 200 includes the user personality information 50, the change promotion information PRM, and the user reaction information RSP. Moreover, the variety of information 200 includes the real data RDT, the demand forecast information DEM, the service parameter SPR, and the like. Examples of the memory device 120 include a volatile memory, a nonvolatile memory, a hard disk drive (HDD), a solid state drive (SSD), and the like.

A service management program 300 is a computer program executed by the processor 110. The functional blocks of the service management system 1 described above (FIGS. 2, 7, and 8) may be implemented by a cooperation of the processor 110 executing the service management program 300 and the memory device 120. The service management program 300 is stored in the memory device 120. The service management program 300 may be recorded on a non-transitory computer-readable recording medium. The service management program 300 may be provided via a network.

The communication device 130 communicates with the user terminal 3 and various devices via a communication network. The processor 110 transmits the change promotion information PRM to the user terminal 3 via the communication device 130. In addition, the processor 110 receives the user reaction information RSP from the user terminal 3 via the communication device 130. Further, the processor 110 collects the real data RDT from the various devices in the real world via the communication device 130.

The input/output device 140 is an interface for receiving information from the service provider and providing information to the service provider. The service provider uses the input/output device 140 to input the setting policy of the service parameter SPR. The processor 110 presents the preferable service parameter SPR to the service provider via the input/output device 140. The service provider reflects the presented service parameter SPR in the real service in the real world.

What is claimed is:

1. A service management system for managing a service, comprising:
one or more memory devices configured to store user personality information indicating personality for each user of the service; and
one or more processors configured to execute:
a service simulation process that simulates a state of the service to estimate a level of the service, based on demand forecast information for the service; and
a change promotion process that notifies a user of change promotion information that promotes a change in a requirement or an action for the service, when the level of the service is lower than a predetermined level, wherein
the change promotion process includes notifying the change promotion information according to the personality of the user based on the user personality information.

2. The service management system according to claim 1, wherein
the user personality information indicates a reaction sensitivity to the change promotion information for each user, and
the change promotion process includes notifying a user whose reaction sensitivity is equal to or higher than a first threshold of the change promotion information without notifying another user whose reaction sensitivity is lower than the first threshold of the change promotion information.

3. The service management system according to claim 1, wherein
the user personality information indicates, for each user, a correspondence relationship between a type of the change promotion information and a reaction sensitivity to the change promotion information, and
the change promotion process includes notifying a user of the change promotion information of a type related to the reaction sensitivity equal to or higher than a second threshold without notifying the user of the change promotion information of another type related to the reaction sensitivity lower than the second threshold.

4. The service management system according to claim 2, wherein
the one or more processors are further configured to acquire user reaction information indicating a reaction of the user to the change promotion information, and to update the user personality information based on the user reaction information.

5. The service management system according to claim 1, wherein
the change promotion process includes notifying all users belonging to a same group of same change promotion information.

6. The service management system according to claim 1, wherein
the one or more processors are further configured to acquire the demand forecast information for the service by simulating an action of the user by using a human model that is an action model of the user.

7. The service management system according to claim 6, wherein
the one or more processors are further configured to:
acquire real data indicating at least one of an actual action history and an action schedule of the user; and
simulate the action of the user by inputting the real data into the human model.

8. A service management method for managing a service, comprising:
a service simulation process that simulates a state of the service to estimate a level of the service, based on demand forecast information for the service; and
a change promotion process that notifies a user of the service of change promotion information that promotes a change in a requirement or an action for the service, when the level of the service is lower than a predetermined level, wherein
the change promotion process includes:
acquiring user personality information indicating personality for each user of the service; and
notifying the change promotion information according to the personality of the user based on the user personality information.
